(19) United States
(12) Patent Application Publication
(10) Pub. No.: US 2017/0264179 A1
(43) Pub. Date: Sep. 14, 2017

(54) Hybrid Electric Motor for Electric Submersible Pump

(71) Applicants: Ivan D. Khotsyanov, Tomilino (RU); Sean A. Cain, Owasso, OK (US); Thien Q. Tran, Mesa, AZ (US); Yong Li, Owasso, OK (US); John M. Knapp, Claremore, OK (US)

(72) Inventors: Ivan D. Khotsyanov, Tomilino (RU); Sean A. Cain, Owasso, OK (US); Thien Q. Tran, Mesa, AZ (US); Yong Li, Owasso, OK (US); John M. Knapp, Claremore, OK (US)

(73) Assignee: Baker Hughes Incorporated, Houston, TX (US)

(21) Appl. No.: 15/450,215

(22) Filed: Mar. 6, 2017

Related U.S. Application Data
(60) Provisional application No. 62/307,076, filed on Mar. 11, 2016.

(51) Int. Cl. H02K 21/46; H02K 5/132; H02K 16/00

(52) U.S. Cl. CPC H02K 21/46; H02K 16/00; H02K 5/132

(57) ABSTRACT

Systems and methods for constructing electric motors including both permanent magnet elements and inductive elements. In one embodiment, a motor is implemented of an ESP system has multiple rotor sections that are mounted end-to-end within the bore of the stator. The permanent magnet elements and inductive elements may be combined within individual rotor sections, or they may be segregated so that one rotor section has only one type or the other. The inductive elements of the rotor allow the motor to be started without a VFD, and without knowing the position of the rotor within the motor. The permanent magnet elements synchronize the rotor with the rotating stator fields when the rotor approaches the operating frequency of the drive.

### CROSS-REFERENCE TO RELATED APPLICATIONS

This application claims the benefit of U.S. Provisional Patent Application 62/307,076, filed Mar. 11, 2016 by Ivan D. Khotsyanov, et al., which is incorporated by reference as if set forth herein in its entirety.

### BACKGROUND

Field of the Invention

The invention relates generally to electric motors, and more particularly to electric motors for electric submersible pumps (ESPs) in which the motors include elements of both permanent magnet motors and induction motors.

Related Art

In the production of oil from geological formations, it is often necessary to use an artificial lift system to maintain the flow of oil. The artificial lift system commonly uses an ESP that is positioned in a well that is drilled into a producing region of the formation. The ESP is connected by a power cable to an electric drive system which is positioned at the surface of the well. The drive generates power (typically three-phase AC power) that is provided to the ESP via the power cable to run the ESP's motor.

ESPs commonly use rotary motors in which a rotor is concentrically positioned in a generally cylindrical stator. The rotor is secured to a shaft that extends from the motor to the pump. As the rotor rotates within the stator, it rotates the shaft, which drives the pump to lift fluids out of the well. The motor may use a permanent-magnet design or an induction design. In either case, the power provided to the motor energizes coils or windings in the stator, producing magnetic fields that interact with fields of the rotor. In the case of a permanent magnet motor, the magnetic fields of the rotor are produced by the permanent magnets. In the case of an induction motor, the rotor's magnetic fields result from currents that are induced in the rotor by the magnetic fields of the stator. Both the permanent magnet motor and the induction motor have their own advantages and disadvantages. For example, the induction motor has a lower power density, efficiency and power factor than the permanent magnet motor, but is simpler to control, rugged and cheaper to manufacture. The permanent magnet motor, on the other hand, requires a variable frequency drive (VFD) or variable speed drive (VSD) to start up. (References herein to “VFD” should be construed to include VFDs and VSDs.) The permanent magnet motor also requires more complex controls to maintain stability during significant load fluctuations, and when the length of the cable between the VFD and the motor is several thousand feet or more. The permanent magnet motor is, however, typically more efficient than an induction motor.

### SUMMARY OF THE INVENTION

This disclosure is directed to systems and methods for constructing electric motors that solve one or more of the problems discussed above by including elements of both permanent magnet motors and induction motors. In one particular embodiment, a motor is implemented in an ESP. This motor has multiple rotor sections that are mounted end-to-end within the bore of the stator. One or more of the rotor sections may have only inductive elements, while others have only permanent magnet elements. Alternatively, the rotor sections may include both induction elements and permanent magnet elements in the same rotor section(s). The inductive elements of the rotor allow the motor to be started without a VFD, and without knowing the position of the rotor with the motor. When the rotor approaches the operating frequency of the drive, the permanent magnet elements synchronize the rotor with the rotating stator fields. At this point, the magnetic fields of the stator no longer induce currents in the inductive elements, and they do not contribute to the torque production of the motor.

In one embodiment, an apparatus comprises an electric motor, where the motor includes a stator having a bore therethrough and a rotor positioned within the bore of the stator. The rotor has both permanent magnet elements and inductive elements. An electric drive generates output power that is provided to the electric motor to run the motor. At startup, the frequency of the output power generated by the electric drive has a frequency that exceeds a frequency of rotation of the motor. In other words, the rotor is stopped, so the rotating magnetic fields of the stator induce currents in the inductive elements of the rotor. The magnetic fields created by the induced currents interact with the fields generated by the stator, causing the rotor to rotate. After startup, when the frequency of the output power generated by the electric drive approaches the frequency of rotation of the motor, the permanent magnet elements of the rotor synchronize with the magnetic fields generated by the stator, so no current is induced in the inductive elements. At this point, the rotor is caused to rotate almost exclusively by the alignment torque induced by the interaction of the rotor permanent magnet field with the stator rotating magnetic field.

In one embodiment, the rotor includes a plurality of rotor sections, where at least one of the plurality of rotor sections includes both permanent magnet elements and inductive elements. The rotor may include one or multiple rotor sections having both permanent magnet elements and inductive elements. The permanent magnet elements in each rotor section may have various configurations. For instance, in one embodiment, the permanent magnets have a straight cross-section and are arranged in a square configuration with each end of each magnet positioned at a periphery of the rotor. The inductive elements are positioned at the periphery of the rotor, radially outward from central portions of the permanent magnet elements. The inductive elements may be thin rotor bars that are positioned at the periphery of the rotor and are secured to the rotor, for example, by a thin non-magnetic sleeve that surrounds the rotor bars and the rotor. Each of the plurality of rotor sections may be identical

In another embodiment, the rotor includes a plurality of rotor sections, but some of the rotor sections have only permanent magnet elements, while other rotor sections have only inductive elements. For example, since the inductive elements are effective primarily when the rotor has not yet reached the frequency of the rotating stator fields, the rotor may include only one rotor section with inductive elements, but may have multiple rotor sections with permanent magnet elements. Although the inductive elements are useful to start the motor and will generate no torque when the permanent magnet rotor sections are synchronized with the stator fields, the inductive elements may also serve to maintain or re-attain synchronization of the permanent magnet rotor sections under changing load conditions.

The motor may be implemented, for example, in an ESP. Because the inductive elements of the rotor can generate a torque in a constant direction to start the motor, as well as provide torque to help maintain synchronization of the permanent magnet elements with the stator, it is not necessary to have a VFD or a complex control system. Instead, the drive can provide output at a non-variable frequency, and it can operate without knowledge of the specific position of the rotor within the motor. The simplification of the control system is particularly useful in the case of ESPs in which the cable length between the drive and motor is very long and makes it difficult for the control system of the drive to obtain timely and accurate feedback from the motor.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating the components of an ESP system in accordance with one embodiment.

FIG. 2 is a diagram illustrating the general structure of an exemplary motor suitable for use in an ESP system in accordance with one embodiment.

FIG. 3 is a diagram illustrating a rotor for an ESP motor in accordance with one embodiment.

FIG. 4 is a diagram illustrating an end view of a permanent magnet rotor section in accordance with one embodiment.

FIG. 5 is a diagram illustrating an end view of an induction rotor section in accordance with one embodiment.

FIG. 6 is a diagram illustrating the structure of an exemplary rotor section having both induction and permanent magnet elements in accordance with one embodiment.

FIG. 7 is a diagram illustrating the structure of an alternative rotor section having both induction and permanent magnet elements in accordance with one embodiment.

FIG. 8 is a diagram illustrating the structure of another alternative rotor section having both induction and permanent magnet elements in accordance with one embodiment.

FIG. 9 is a diagram illustrating the structure of another alternative rotor section having both induction and permanent magnet elements in accordance with one embodiment.

FIG. 10 is a diagram illustrating the structure of another alternative rotor section having both induction and permanent magnet elements in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as described herein. Further, the drawings may not be to scale, and may exaggerate one or more components in order to facilitate an understanding of the various features described herein.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

This disclosure is directed to systems and methods for constructing electric motors for ESPs in which the motors include elements of both permanent magnet motors and induction motors. The combination of elements of permanent magnet and induction motors may overcome one or more of the disadvantages of each of these individual types of motors.

Various factors come into play when determining the design of downhole electric motors such as are used in ESP systems. For instance, it is generally desirable to use higher efficiency motors (both for the sake of economy and to meet the demands of legislation aimed at reducing on greenhouse gas emissions). As noted above, permanent magnet motors generally have higher power densities, efficiencies and power factors than induction motors of the same outer diameter and power rating. Higher power density is favorable and can make low-cost rigless ESP deployment and replacement feasible, although the higher power density will cause a higher loss per unit volume and temperature rise if the efficiency remains the same. It is difficult to increase the power density of an induction motor without improving its efficiency, and this is limited by the materials used in the construction of the motors. The higher efficiency of a permanent magnet motor can result in the same or lower loss or temperature rise with respect to an induction motor, even though the permanent magnet motor has a higher power density than the induction motor for the same speed.

While the greater efficiencies and higher power factors of permanent magnet motors can reduce the life-cycle cost of these motors, the initial cost of an ESP system using a permanent magnet motor is typically higher than that of a system using an induction motor. This is, in part, a result of the fact that permanent magnet motors normally require a VFD. The lower initial cost of a system using an induction motor, in addition to the fact that induction motors are relatively rugged, may make these systems more attractive.

Increasingly, market forces are driving up the demand for ESP systems having permanent magnet motors. As mentioned above, however, there are several significant problems with these systems. One of these problems is that a conventional permanent magnet motor normally requires a VFD in order to start the motor. At startup, the frequency of the drive's output must be relatively low—if it is too high, it may not overcome the rotor's inertia, and may simply cause the rotor to oscillate. The VFD's inverter must also have a high enough rating that it can provide sufficiently high current to overcome the inertia of the rotor at startup. Another problem with conventional permanent magnet motors is that they are unstable. These motors may experience oscillations or variation of the motor's speed with fluctuations in the load on the motor. If the variations are great enough, they may cause de-synchronization of the motor. It is therefore typically necessary to implement relatively complex control schemes to run permanent magnet motors.

In the present systems, the problems of the permanent magnet motors are addressed by including inductive elements in the motor. This may be accomplished in various ways. For example, because ESP motors are normally very long and narrow, rotors for these motors commonly have multiple rotor sections that are mounted end-to-end within the bore of the stator. One embodiment may therefore include one or more rotor sections that have only inductive elements, as well as one or more rotor sections that have only permanent magnet elements. Another embodiment may include both induction elements and permanent magnet elements in the same rotor section(s). Each of these embodiments will be discussed in more detail below.

Because the present motors have inductive rotor elements (whether in separate rotor sections, or combined with permanent magnet elements in the same rotor section), they can be easily started without a VFD. As with other induction motors, providing a power to the stator and thereby generating rotating magnetic fields in the stator induces currents in the induction elements of the rotor. These currents in turn generate magnetic fields that interact with those of the stator. The interacting magnetic fields produce a torque on the rotor in a constant direction, so it is not necessary to vary the frequency of the drive output (i.e., start at a low frequency and gradually increase to a normal operating frequency). Due to the induction element, it is not necessary to know the rotor position during the startup. The drive can simply generate output power that is independent of the rotor position. The torque of the induction elements helps to bring the rotor up to the operating frequency, at which the permanent magnet elements synchronize the rotor with the rotating stator fields. The induction elements try to catch up to the rotating magnetic fields of the stator, but they always remain a bit behind. At some point, the rotor is rotating fast enough that the permanent magnet elements of the rotor can synchronize with the magnetic fields of the stator. At this point, the magnetic fields of the stator no longer induce currents in the inductive elements, and they do not contribute to the torque of the motor.

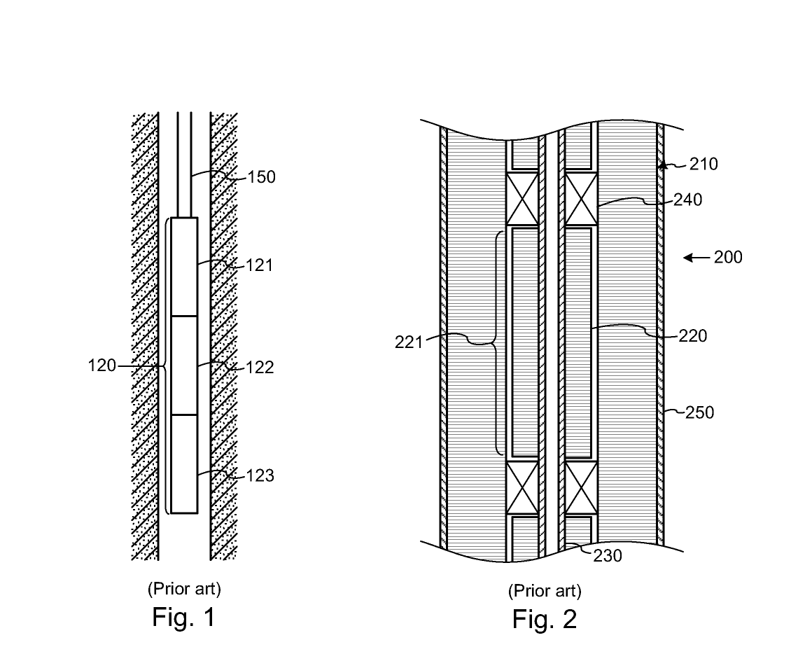

Referring to FIG. 1, a diagram illustrating the components of an ESP system in one embodiment is shown. In this embodiment, an ESP system is implemented in a well for producing oil, gas or other fluids. An ESP system 120 is coupled to the end of tubing string 150, and the ESP system and tubing string are lowered into the wellbore to position the pump in a producing portion of the well. A drive system (not shown) at the surface of the well provides power to the ESP system 120 to drive the system's motor.

ESP system 120 includes a pump section 121, a seal section 122, and a motor section 123. ESP system 120 may include various other components which will not be described in detail here because they are well known in the art and are not important to a discussion of the invention. Motor section 123 is coupled by a shaft through seal section 122 to pump section 121. Motor section 123 rotates the shaft, thereby driving pump section 121, which pumps the oil or other fluid through the tubing string 150 and out of the well. It should be noted that the ESP system may include other components that are not explicitly shown in the figure.

Referring to FIG. 2, a diagram illustrating the general structure of an exemplary motor suitable for use in an ESP system is shown. As depicted in this figure, motor 200 has a stator 210 and a rotor 220. Stator 210 is generally cylindrical, with a coaxial bore that runs through it. Rotor 220 is coaxially positioned within the bore of stator 210. Rotor 220 is attached to a shaft 230 that is coaxial with the rotor and stator 210. In this example, rotor 220 includes multiple sections (e.g., 221), where bearings (e.g., 240) are positioned at the ends of each section. The bearings 240 support shaft 230, and consequently rotor 220, within the bore of stator 210 and allow the rotor and shaft 230 to rotate within the stator. Stator 210 may be constructed as a single unit, or it may be constructed by connecting multiple stator sections end-to-end within a housing 250.

In conventional motors, the rotor will use either permanent magnets or inductive rotor bars, but not both. In embodiments of the present invention, the motors include both permanent magnets and inductive rotor bars. In some embodiments, the motor's rotor is formed by connecting one or more permanent magnet rotor sections and one or more inductive rotor sections end-to-end. In other embodiments, individual rotor sections may include both permanent magnets and inductive rotor bars.

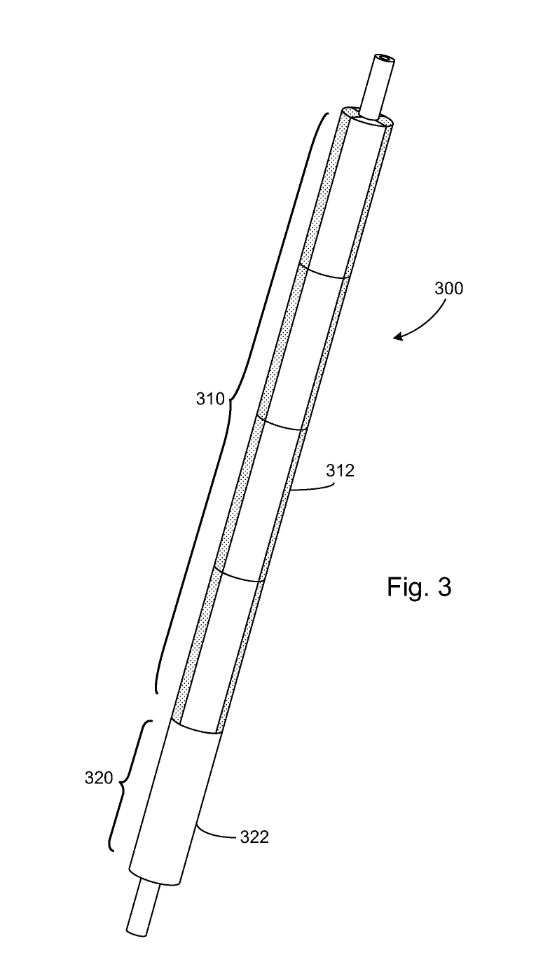

Referring to FIG. 3, a diagram illustrating a rotor for an ESP motor in accordance with one embodiment is shown. In this embodiment, rotor 300 has a first portion (310) that uses permanent magnets and a second portion (320) that uses inductive rotor bars. Each of portions 310 and 320 may include one or more individual rotor sections. In this particular embodiment, portion 310 has multiple permanent magnet rotor sections (e.g., 312), while portion 320 has a single induction rotor section 322. The relative numbers of permanent-magnet and inductive rotor sections may vary from one embodiment to another. In the figure, the rotor is depicted as having four permanent magnet rotor sections and one inductive rotor section. The ratio of rotor types, however, is driven by the design and application of the motor, and depends on many factors specific to individual cases. It should be kept in mind that there must be enough induction rotor capacity to accelerate the load (e.g., a pump) to near-synchronous speed, and there must be enough permanent magnet rotor capacity to run that load at full synchronous speed, continuously, without the aid of the induction rotors.

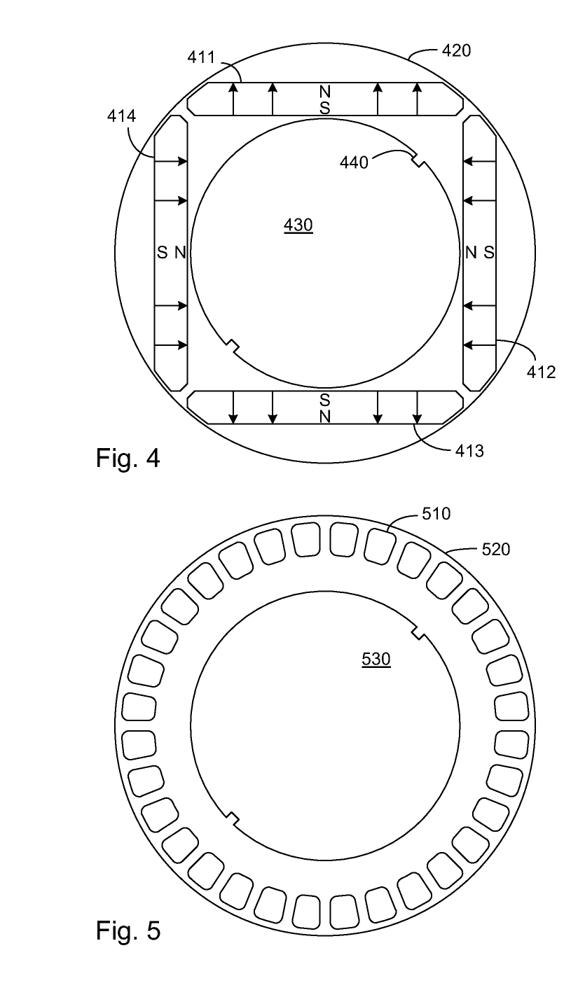

Referring to FIGS. 4 and 5, diagrams illustrating exemplary structures for the rotor sections of FIG. 3 are shown. FIG. 4 depicts an end or cross-sectional view of a permanent magnet rotor section, while FIG. 5 depicts an end or cross-sectional view of an induction rotor section.

As shown in FIG. 4, the permanent magnet rotor section employs a set of permanent magnets 411-414 that are installed in a rotor core that is constructed by stacking a set of thin metal laminations 420. The shaft of the motor is positioned in the bore (430) formed through the rotor core. Keys (e.g., 440) may be provided in the bore of the rotor core to mate with corresponding keyways in the motor shaft and thereby prevent rotation of the rotor section with respect to the shaft. Permanent magnets 411-414 are arranged in a square configuration with the ends of the magnets adjacent to each other. The north poles of magnets 411 and 413 point outward, while the south poles of magnets 412 and 414 point inward. This permanent magnet rotor section therefore has four poles. In alternative embodiments, the rotor section may be designed to have more or fewer (e.g., two) poles. Similarly, the shapes and positions of the magnets may vary from one embodiment to another.

Referring to FIG. 5, the induction rotor section is also constructed by stacking a set of thin metal laminations (520) to form the core of the rotor section. A bore (530) is provided through the center of the core so that the rotor section can be positioned on the shaft of the motor. A set of electrically conductive rotor bars (e.g., 510) are installed in the core. Each bar extends from one end of the rotor section to the other and is connected to an electrically conductive plate at each end of the rotor section, forming a structure that is commonly referred to as a “squirrel cage”. Like the permanent magnet rotor sections, the configuration of the induction rotor section may vary from one embodiment to another. For example, there may be a different number of rotor bars, the rotor bars may have different cross-sectional shapes and areas, the rotor bars may have different positions, and so on.

While the rotor of FIG. 3 is depicted as having four permanent magnet rotor sections and one induction rotor section, this ratio may vary in other embodiments. The ratio, the induction rotor section should be determined so that the induction rotor sections can provide enough torque to start the motor but do not substantially reduce the motor's efficiency when the permanent magnet rotor sections have synchronized with the stator. It should be noted that, although the induction rotor section does not contribute to the rotor's torque when the rotor is synchronized with the stator's magnetic fields, it may help damp oscillations experienced by the rotor due to fluctuations in the load on the motor. For example, if the load suddenly increases, the permanent magnet rotor sections may lag behind the stator's rotating magnetic fields. This induces currents in the induction rotor section, and the resulting magnetic fields produced in the induction rotor section add to the overall torque of the rotor, reducing the oscillation caused by the fluctuating load. From an energy perspective, the induced current in the rotor bars will generate a Lorentz force to oppose the relative motion of rotor with respect to stator magnetic field. This force will damp the relative motion between the stator and the rotor magnetic field.

As an alternative to having separate induction rotor sections and permanent magnet rotor sections, the induction and permanent magnet elements may both be incorporated into the same rotor sections. By incorporating both induction and permanent magnet elements into the same rotor sections, several additional advantages may be achieved. For instance, rather than having to manufacture two different types of rotor sections (induction rotor sections and permanent magnet rotor sections), it is only necessary to manufacture a single type of rotor section (a combined induction and permanent magnet rotor section). Additionally, every rotor would always be contributing to torque production, and the effects of the induction elements (i.e., the torque produced by these elements) would be more evenly distributed throughout the length of the rotor, rather than being concentrated at the location of a single induction rotor section

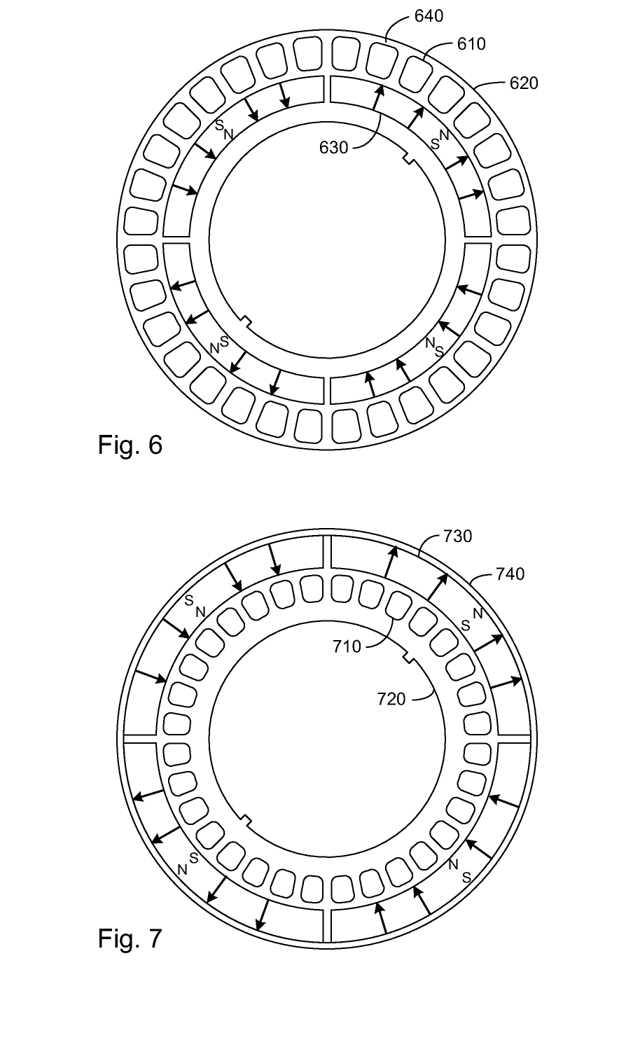

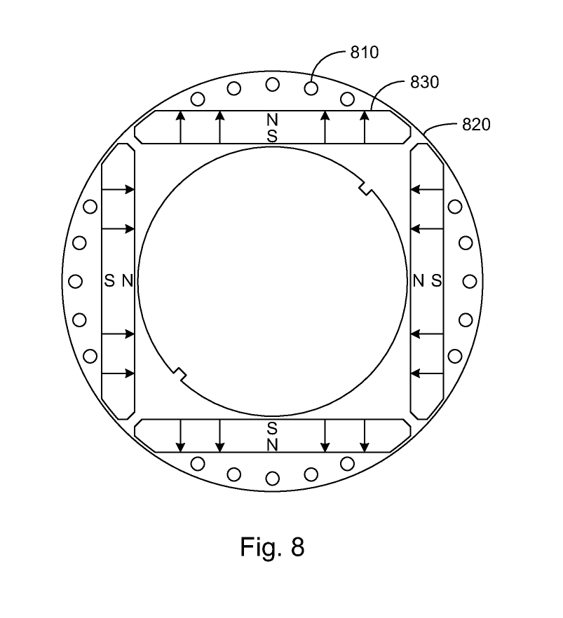

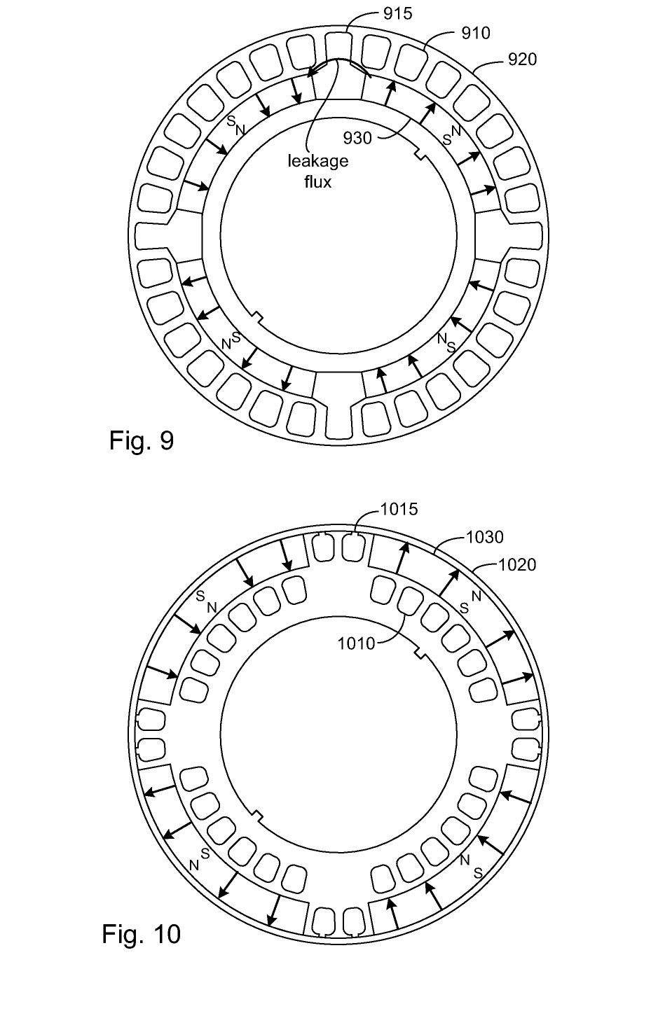

Referring to FIGS. 6-10, several embodiments of rotor sections that combine both induction elements and permanent magnet elements are shown. FIG. 6 is a diagram illustrating the structure of a rotor section in which a set of rotor bars are positioned near the outer periphery of the rotor section, while a set of permanent magnets are positioned radially inward from the rotor bars. FIG. 7 is a diagram illustrating the structure of a rotor section in which a set of permanent magnets are positioned on the outer periphery of the laminated rotor core, and are secured by a thin nonmagnetic retaining sleeve, while a set of rotor bars are positioned radially inward from the permanent magnets. FIG. 8 is a diagram illustrating the structure of a rotor section in which the rotor bars are positioned near the outer periphery, while the rectangular permanent magnets are embedded in the rotor section. FIG. 9 is a diagram illustrating the structure of a rotor section in which a set of rotor bars are positioned near the outer periphery of the rotor section with a set of permanent magnets positioned radially inward from the rotor bars, wherein flux barriers, which are free space with air, extend from the ends of the permanent magnets to the periphery of the rotor section. FIG. 10 is a diagram illustrating the structure of a rotor section in which curved permanent magnets are positioned on the outer periphery of rotor core, and are secured by a thin nonmagnetic retaining sleeve, and rotor bars are positioned both radially inward from the permanent magnets and at the periphery of the rotor section between the ends of the permanent magnets. The rotor slots on the rotor periphery where the rotor bars are placed are open slots, in comparison to the rotor slots located inward from the permanent magnets. The open slot is made possible with the introduction of a retaining sleeve. The advantage of the open slot over the closed slot is that there is less flux leakage and high transient torque produced during startup or load oscillation, while for embodiment 6, 8 and 9, the rotor bars should be placed in closed slots to reduce the friction loss.

Referring to FIG. 6, the structure of a first exemplary rotor section that combines both induction and permanent magnet elements is shown. In this embodiment, a core 620 of the rotor section is formed by stacking annular laminations or by any other suitable means. Rotor bars (e.g., 610) are positioned around the core near its periphery. The positioning of the rotor bars in this embodiment is substantially the same as in a conventional induction rotor section. In this embodiment, however, permanent magnets (e.g., 630) are also installed in the core. The permanent magnets are positioned radially inward from the rotor bars. Because the induction elements (the rotor bars) in this embodiment are positioned very near the outer diameter of the rotor section (the bridge 640 is around 15 mils, and is exaggerated in the figure for clarity), they are located where the magnetic flux density and “flux cutting” speed is higher, so the transient torque is maximized for the same slip. The permanent magnets, on the other hand, are positioned radially inward from the rotor bars, so the coverage of the permanent magnets is diminished in comparison to the case in which they are placed closer to outer diameter of the rotor section. The less permanent magnet coverage means less flux and flux linkage to the stator winding, and less alignment torque production from the permanent magnet.

Referring to FIG. 7, the structure of a second exemplary rotor section that combines both induction and permanent magnet elements is shown. In this embodiment, a core 720 of the rotor section is formed by stacking annular laminations or by any other suitable means. Permanent magnets (e.g., 730) are positioned on the periphery of the core and are secured by a thin nonmagnetic retaining sleeve 740, as might be found in a conventional permanent magnet rotor section. In this embodiment, rotor bars (e.g., 710) are positioned radially inward from the permanent magnets. Because the permanent magnets are positioned on the outer diameter of the rotor section, they have maximum pole coverage and flux linkage, so that they can produce higher permanent magnet torque during steady state operation at synchronous speed. The rotor bars, however, are positioned radially inward from the permanent magnets, where they have less magnetic flux density. Less flux will be “cut” by rotor bars, and they also have lower “flux cutting” speed, so that less transient torque is produced than in the case in which rotor bars are placed close to the outer diameter of the rotor that shown in FIG. 5 and FIG. 6.

Because, in the embodiments of FIGS. 6 and 7, one of the types of elements (induction or permanent magnet) is positioned radially inward, away from the outer diameter of the rotor section, the effects of this element are diminished. FIG. 8 is a diagram illustrating the structure of a third exemplary rotor section that combines both induction and permanent magnet elements. In this embodiment, the core 820 has both rotor bars (e.g., 810) and permanent magnets (e.g., 830) installed in it. The permanent magnets in this case are straight and have the same configuration as the conventional permanent magnet rotor section of FIG. 4, with each magnet lying essentially along a chord between two points on the periphery of the rotor. The permanent magnet torque is determined by the flux linkage which is produced by the magnets and crosses the air gap to the stator windings. Magnetic flux depends on the pole coverage of the permanent magnets and the MMF (Magnetomotive Force). The straight or rectangular magnet has less pole coverage than curved magnets on the periphery of rotor such as in the embodiment of FIG. 7.

Because the periphery of the core curves away from the central portion of each magnet, there is an opportunity to position rotor bars in the space between the central portion of the magnet and the outer diameter of the core. In the embodiment of FIG. 8, 5 rotor bars are positioned near the outer diameter of the core adjacent to the central portion of each permanent magnet. The sizes and numbers of the rotor bars may vary in alternative embodiments. Because the rotor bars can be positioned near the outer diameter of the rotor section where the magnetic flux density and the speed of “flux cutting” is higher, it can induce higher current in rotor bars and transient torque during startup and higher damping during load oscillation. The application of rectangular magnets will result in less magnet coverage than that in the embodiment of FIG. 7, and less steady state torque produced, but the transient torque will be higher than the embodiment of FIG. 7. Rectangular magnets will be less costly to manufacture than curved magnets of embodiment of FIG. 7. This embodiment thereby provides the benefits of both permanent magnet and induction rotor sections without substantially diminishing the effectiveness of either one.

Referring to FIG. 9, a diagram illustrating the structure of another exemplary rotor section that combines both induction and permanent magnet elements is shown. In this embodiment, rotor bars (e.g., 910) are positioned around the core 920 of the rotor section near its periphery. Permanent magnets (e.g., 930 are positioned radially inward from the rotor bars at the periphery of the rotor section. Four flux barriers (e.g., 915), which are free space with air, are positioned at the ends of the permanent magnets and extend to the periphery of the rotor section so that the magnetic fields of the permanent magnets are channeled to the outer diameter of the rotor section. The flux leakage from each magnet to adjacent magnets will therefore be reduced, and there will be more flux across the air gap that links the stator winding to produce torque.

Referring to FIG. 10, the structure of another alternative rotor section that combines both induction and permanent magnet elements is shown. In this embodiment, curved permanent magnets (e.g., 1030) are positioned around the periphery of the core 1020. Two sets of rotor bars are also installed in the core. A first set of the rotor bars (e.g., 1010) is positioned radially inward from the permanent magnets. A second set of the rotor bars (e.g., 1015) is positioned at the periphery of the rotor section between the ends of the permanent magnets. The rotor bars placed at the rotor periphery can produce more transient torque during both startup and load oscillation. The number of rotor bars at the rotor periphery is determined by the requirement of starting torque and the amplitude of load oscillation, but increasing the number will reduce the coverage of the permanent magnet or the total flux linkage, and the torque produced during the steady state at synchronous speed.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the description herein.

What is claimed is:

1. An apparatus comprising:
an electric motor, wherein the motor includes a stator having a bore therethrough and a rotor positioned within the bore of the stator, wherein the rotor has a plurality of permanent magnet elements and a plurality of inductive elements; and
an electric drive coupled to the motor, wherein the electric drive generates output power that is provided to the electric motor;
wherein at startup, the output power generated by the electric drive has a frequency that exceeds a frequency of rotation of the motor, thereby inducing currents in the inductive elements, wherein magnetic fields created by the induced currents cause the rotor to rotate; and
wherein after startup, when the frequency of the output power generated by the electric drive matches the frequency of rotation of the motor, no current is induced in the inductive elements, wherein magnetic fields created by the permanent magnet elements cause the rotor to rotate.

2. The apparatus of claim 1, wherein the rotor includes a plurality of rotor sections, wherein at least one of the plurality of rotor sections has both one or more of the plurality of permanent magnet elements and one or more of the plurality of inductive elements.

3. The apparatus of claim 2, wherein each of the plurality of rotor sections has both one or more of the plurality of permanent magnet elements and one or more of the plurality of inductive elements.

4. The apparatus of claim 3, wherein in each rotor section, the permanent magnet elements each have a straight cross-section and are arranged in a square configuration with each end of each magnet positioned at a periphery of the rotor, wherein the inductive elements are positioned at the periphery of the rotor radially outward from central portions of the permanent magnet elements.

5. The apparatus of claim 4, wherein each of the plurality of rotor sections is identical.

6. The apparatus of claim 3, wherein the inductive elements comprise rotor bars that are positioned at the periphery of the rotor and are secured to the rotor by a thin non-magnetic sleeve that surrounds the rotor bars and the rotor.

7. The apparatus of claim 1, wherein the rotor includes a plurality of rotor sections, wherein at least one of the plurality of rotor sections has only one or more of the plurality of permanent magnet elements and at least one of the plurality of rotor sections has only one or more of the plurality of inductive elements.

8. The apparatus of claim 7, wherein the rotor includes only a single one of the rotor sections that has only the inductive elements, and wherein the rotor includes two or more of the rotor sections that have only the permanent magnet elements.

9. The apparatus of claim 1, wherein the output power generated by the electric drive has a non-variable frequency.

10. The apparatus of claim 1, wherein the electric drive operates independently of a position of the rotor within the stator.

11. The apparatus of claim 1, wherein the electric motor is coupled to a pump and drives the pump, wherein the pump and electric motor are installed downhole in well, wherein the electric drive is installed at the surface of the well, and wherein a power cable extending into the well from the electric drive to the electric motor carries the output power from the electric drive to the electric motor.

12. An electric submersible pump (ESP) system comprising:
a pump;
an electric motor coupled to drive the pump;
wherein the pump and motor are installed in a well;
a power cable coupled to the electric motor; and
an electric drive coupled to the power cable, wherein the electric drive generates output power that is provided to the electric motor via the power cable;
wherein the electric motor includes stator and a rotor, wherein the rotor has a plurality of permanent magnet elements and a plurality of induction elements;
wherein at startup, the output power generated by the electric drive has a frequency that exceeds a frequency of rotation of the motor, thereby inducing currents in the inductive elements, wherein magnetic fields created by the induced currents cause the rotor to rotate; and
wherein after startup, when the frequency of the output power generated by the electric drive matches the frequency of the motor, no current is induced in the inductive elements, wherein magnetic fields created by the permanent magnet elements cause the rotor to rotate.

13. The ESP system of claim 12, wherein the rotor includes a plurality of rotor sections, wherein one or more of the plurality of rotor sections has both one or more of the plurality of permanent magnet elements and one or more of the plurality of inductive elements.

14. The ESP system of claim 13, wherein each of the plurality of rotor sections is identical

15. The ESP system of claim 12, wherein the rotor includes a plurality of rotor sections, wherein at least one of the plurality of rotor sections has only one or more of the plurality of permanent magnet elements and at least one of the plurality of rotor sections has only one or more of the plurality of inductive elements.
